(19) United States
(12) Patent Application Publication
(10) Pub. No.: US 2022/0021289 A1
(43) Pub. Date: Jan. 20, 2022

(54) ADJUSTABLE FORCE DEVICE

(71) Applicant: Moving Magnet Technologies, Besançon (FR)

(72) Inventors: Jean-Daniel Alzingre, Larnod (FR); Corentin Le Denmat, Besancon (FR); Bastiste Galmes, Besancon (FR)

(21) Appl. No.: 17/295,737

(22) PCT Filed: Nov. 29, 2019
(86) PCT No.: PCT/FR2019/052851

§ 371 Date: May 20, 2021

(30) Foreign Application Priority Data
Nov. 29, 2018 (FR) 1872071

(51) Int. Cl. H02K 37/04; H02K 7/116; H02K 37/24; E05F 5/02; E05F 3/00

(52) U.S. Cl. CPC H02K 37/04; H02K 7/116; H02K 37/24; E05Y 2201/462; E05F 3/00; E05Y 2900/132; E05F 5/027

(57) ABSTRACT

An adjustable force device comprises a member that is mechanically guided for allowing a displacement according to a predetermined trajectory, and means for magnetically indexing the displacement by the magnetic interaction between a first ferromagnetic structure and a second ferromagnetic structure integral with a magnet, wherein the magnet is at least partially surrounded by an electric coil that modifies the magnetization of the permanent magnet according to the direction and the amplitude of the electric current flowing in the coil.

### CROSS-REFERENCE TO RELATED APPLICATIONS

This application is a national phase entry under 35 U.S.C. § 371 of International Patent Application PCT/FR2019/052851, filed Nov. 29, 2019, designating the United States of America and published as International Patent Publication WO 2020/109744 A2 on Jun. 4, 2020, which claims the benefit under Article 8 of the Patent Cooperation Treaty to French Patent Application Serial No. 1872071, filed Nov. 29, 2018.

### TECHNICAL FIELD

The present disclosure relates to the field of indexing devices comprising a button or an accessory that is movable according to a rotary or linear displacement, for example, an adjustment button associated with an electromagnetic sensor for providing an analog signal that represents the position and/or displacement of the control button.

Such a device generally comprises a manual control member that, when actuated by a user, causes the activation of the above-mentioned element according to the various positions occupied by this member.

It is important that the user feels a tactile effect, for example, by passing over a hard point, when acting on this control member, so as to have the sensation that the maneuver has actually been carried out or to haptically perceive the number of increments resulting from the user's manipulation by creating haptic feedback by touch. This effect corresponds to indexing of the position of the control member. It is also important to be able to dynamically modify the sensation felt depending, for example, on the type of control carried out with the same button or when the action has been carried out by the system, thus enriching the information given and the user experience.

This control device is used by way of example in the automotive industry: It can be used in a vehicle, for example, to control the operation and adjustment of lights, mirrors, windshield wipers, air conditioning, infotainment, radio or the like.

It is also used in various industries, in particular, for adjusting domestic or industrial equipment. This device can also be integrated in an electric motor in order to achieve an adjustable force such as a controllable residual torque (without current in the motor), or a force for returning to a predefined stable position.

### BACKGROUND

Manual control devices are already known from the prior art, such as microswitches or spring-loaded push-buttons of which the position is mechanically indexed on a notched ramp.

In these devices, the friction between the mechanical parts generally causes parasitic forces and premature wear.

Solutions using magnetic interaction have also been proposed. EP1615250B1 describes a device for controlling at least one element, in particular, an electrical circuit or a mechanical member, comprising a housing, a manual control member, means for indexing the position of the control member, consisting of two permanent magnets of opposite polarity in the form of a ring or a disk, one stationary and rigidly connected to the housing and the other movable, rigidly connected to the control member and mounted perpendicularly to the longitudinal axis thereof, and means for activating the element, which act on it according to the various positions, referred to as “working” positions, occupied by the control member.

FR2804240 describes a device for controlling electrical functions in the automobile by magnetic switching. It comprises a housing; a manual rotary control member, which is rigidly connected to an axis of rotation on which an element is mounted, which comprises means for indexing the position of the control member; and switching means that cooperate with an electrical conduction circuit to provide electrical information corresponding to the various displacements of the control member; and it is characterized in that the indexing means consist of permanent magnets, some of which are stationary and the others of which are rotatable with the axis of rotation.

WO2011154322 describes a control element for a switching and/or adjustment function having at least two switching or adjustment stages, comprising: a manually actuatable control element that can be displaced from a rest position; at least three permanent magnets comprising: a first movable permanent magnet that is driven in a synchronized manner, in its displacement zone, by the control element; a second movable permanent magnet that is driven, by magnetic flux, in a first partial zone of the displacement zone of the first permanent magnet in a manner synchronized by the latter, and of which the subsequent displacement, in at least a second partial zone of the displacement zone of the first permanent magnet, is blocked by at least one stop; and a third permanent magnet that is stationary relative to the control element for generating a magnetic restoring force, on at least the first permanent magnet.

The prior art solutions are not completely satisfactory firstly because the stiffness of the indexing is fixed and constant: it is not possible with the prior art solutions to vary the nature of the haptic interaction in a circumstantial manner, for example, by reducing the stiffness when the control button is close to a target position and, on the contrary, increasing it when the target position is far away and requires displacements with greater jumps.

The present disclosure aims to remedy this drawback by allowing a parameterizable adjustment of the indexing stiffness law without power consumption during the displacement of the control member, except during times in which the stiffness changes.

Such a solution excludes, in particular, a motorized control button that requires a continuous power supply.

### BRIEF SUMMARY

In order to respond to these technical problems, the present disclosure relates in its most general sense to an adjustable force device comprising a mechanically guided member for allowing a displacement along a predetermined trajectory and means for magnetically indexing the displacement by the magnetic interaction between a first ferromagnetic structure and a second ferromagnetic structure rigidly connected to a magnet, wherein the magnet is surrounded at least partially by an electric coil that modifies the magnetization of the permanent magnet according to the direction and amplitude of the electric current flowing in the coil.

The term “magnetic interaction” is understood to mean any force created by magnetic means by variation of the overall magnetic reluctance of the magnetic circuit formed by the first and second ferromagnetic structures and the magnet. This may involve, for example, toothed structures or structures having variable air gaps or the interaction of the low-coercive-field magnet with another magnet.

The present disclosure also relates to an adjustment device, excluding a computer pointing device, comprising a mechanically guided member for allowing a displacement along a predetermined trajectory and means for magnetically indexing the displacement by the magnetic interaction between a first ferromagnetic structure and a second ferromagnetic structure rigidly connected to a magnet, wherein the magnet is surrounded at least partially by an electric coil that modifies the magnetization of the permanent magnet according to the direction and amplitude of the electric current flowing in the coil.

Preferably,
the magnet is a magnet with a coercive field of less than 100 kA/m;
the second magnetized ferromagnetic structure is also rigidly connected to a second permanent magnet with a coercive field of greater than 100 kA/m;
the second ferromagnetic structure is also magnetically closed by a magnetic short-circuit connecting the two opposite polarities of the magnet; and/or
the second ferromagnetic structure defines, with the first ferromagnetic structure, a first air gap on the side of the first polarity of the magnet and a second air gap on the side of the second polarity of the magnet.

According to one variant, the adjustable force device according to the present disclosure further comprises an electronic circuit controlling the power supply to the coil in a pulsed manner.

Advantageously,
the first structure and second structure have teeth and the second ferromagnetic structure consists of two toothed semi-tubular parts connected on the one hand by the second magnet and on the other hand by the first magnet, the directions of magnetization of the two magnets being parallel;
the angular deviation between the teeth is identical between the first and the second structure;
the angular deviation between the teeth is different between the first and the second structure;
the second ferromagnetic structure consists of two coaxial disks separated by the two magnets, which magnets have a tubular shape and axial magnetization and are arranged coaxially with the disks; and/or
the device is rotary and the first ferromagnetic structure and the second magnetic structure form a variable air gap according to the relative angular position of the structures.

The present disclosure also relates to an electric motor comprising an adjustable force device according to the present disclosure, wherein the device is integrated in the stator of an electric motor and in that the device controls a force for holding in a stable position or returning to a predefined position.

Advantageously, the first structure is the cylinder head of an electric motor and the device controls a force for holding in a stable position or returning to a predefined position.

### BRIEF DESCRIPTION OF THE DRAWINGS

The present disclosure will be better understood on reading the following description, which concerns non-limiting embodiments illustrated by the accompanying figures, in which:

FIG. 1 is a perspective view of a first example of the electromagnetic structure of the device;

FIGS. 2a and 2b are a sectional and a top view, respectively, of the example from FIG. 1;

FIGS. 3a and 3b show, in a second variant of the electromagnetic structure, the magnetic field lines according to the nature of the magnetization of the semi-remanent magnet;

FIG. 4 is a perspective view in partial section of the electromagnetic structure, according to a variant of a device according to the present disclosure;

FIGS. 5a-5c are top views of a device, according to the present disclosure in another embodiment, with the layout of the magnetic field lines;

FIG. 6 is a perspective view in partial section of the electromagnetic structure, according to a variant of a device according to the present disclosure,

FIG. 7 is a perspective view in partial section of the electromagnetic structure, according to another variant of a device according to the present disclosure;

FIG. 8 is a perspective view in partial section of the electromagnetic structure, according to another variant of a device according to the present disclosure;

FIG. 9 shows an embodiment of a linear movement device, according to the present disclosure;

FIGS. 10a-10c show different views, namely isolated, and integrated in a gear motor in a top view and in a sectional view, respectively, of an alternative embodiment of a device integrated in an electric motor for producing a force for returning to a predefined position;

FIG. 11 shows another embodiment of a device, according to the present disclosure, integrated in an electric motor;

FIG. 12 shows an alternative embodiment of a device, according to the present disclosure, integrated in a control button;

FIGS. 13a and 13b show an alternative embodiment of a device, according to the present disclosure, for managing the progressive thrust of a spring;

FIGS. 14a and 14b show two cross-sectional views of a device, according to the present disclosure according to a particular embodiment, which makes it possible to generate two different types of notching;

FIGS. 15a and 15b show two cross-sectional views of a device, according to the present disclosure according to two different embodiments, for generating more than two different notching types;

FIG. 16 is a cross-sectional view of a device, according to the present disclosure, which can be integrated in an actuator in order to generate a controlled braking torque;

FIG. 17 is a perspective view of a device, according to the present disclosure, in an alternative embodiment to that shown in FIG. 10a;

FIG. 18 is a block diagram of an example of a user interface using a device according to the present disclosure; and

FIG. 19 is two views, in perspective and in longitudinal section, respectively, of an example of a user interface, which incorporates a device according to the present disclosure and is capable of being oriented according to at least three different degrees of freedom.

### DETAILED DESCRIPTION

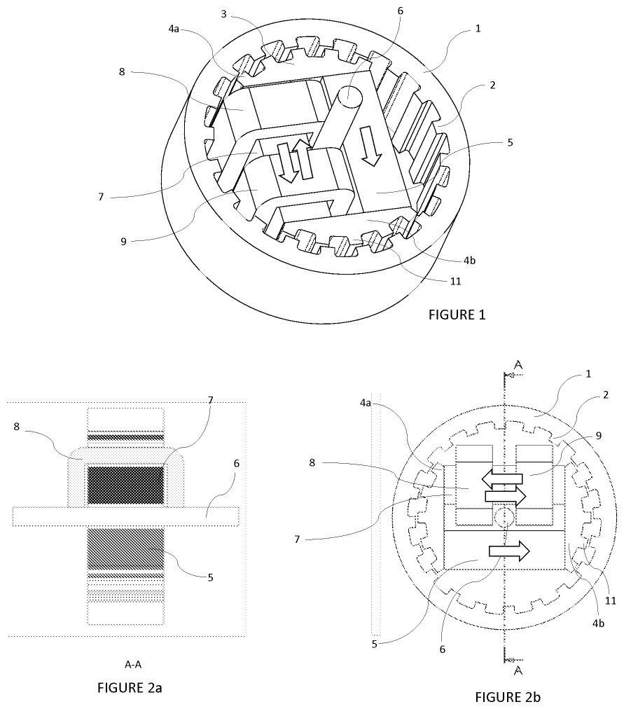

FIG. 1 is a schematic perspective view of a first embodiment of an electromagnetic structure of the indexing device and FIGS. 2a and 2b show a sectional view and a top view, respectively, of such a device. In FIGS. 1 and 2b, the thick arrows show the direction of magnetization of the elements.

This example of an indexing device consists of a first structure (1) formed by a toothed cylinder that is made of a ferromagnetic material and, in the example shown, has 20 teeth (2) extending radially, the number of teeth not being limiting. This first structure (1) is in rotation about the axis (6) and is coupled to a manually actuated control button (not visible here).

A second toothed ferromagnetic structure (3) is arranged coaxially inside this first structure (1), and is stationary relative to the movement of the first structure (1). This second ferromagnetic structure (3) consists of two stationary semi-tubular parts (4a, 4b) having teeth (11) that extend radially toward the teeth (2) of the first structure and with the same angular deviation as that of the teeth (2) of the first structure (1). Such an identical angular deviation for the teeth (2) and (11) makes it possible to maximize the force between the first structure (1) and the second structure (3) and therefore to maximize the haptic sensation given to the user. However, the adjustment of this haptic sensation will advantageously be made possible by the number of teeth on the two structures (1, 3) and possibly by a difference in the angular deviation between the teeth (2, 11) or even by the different widths of the teeth (2, 11) between the two structures (1, 3).

The two semi-tubular parts (4a, 4b) are connected on the one hand by a first permanent magnet (5), preferably of high energy incorporating a rare earth, with a typical magnetic remanence greater than 0.7 Tesla and a high demagnetization coercive field, typically of 600 kA/m, and in any case greater than 100 kA/m. The direction of magnetization is along the largest dimension of the magnet, in this case in a direction orthogonal to the axis (6) of rotation. The permanent magnet (5) has a function of generating a constant magnetic field, and must not become demagnetized during use of the device.

These two semi-tubular parts (4a, 4b) are also connected on the other hand by a second magnet (7) having a low coercive field, that is to say, a magnet of the semi-remanent type or of the AlNiCo type, with a remanence typically of 1.2 Tesla, and a typical coercive field of 50 kA/m, and in any case of less than 100 kA/m. The direction of magnetization is along the largest dimension of the magnet and in such a way that the magnetic fluxes of the two magnets (5) and (7) are additive or subtractive, depending on the magnetization imparted to the second, low-coercive-field magnet (7), with the magnetic fluxes flowing in the semi-tubular parts (4a, 4b). The low coercive field of the magnet (7) is necessary in order to allow it to be magnetized or demagnetized easily by means of a coil located around it, and this takes place with limited energy, which makes its use in an integrated device possible without the use of powerful and expensive electronics.

This second magnet (7) is arranged in parallel with the first permanent magnet (5) and is surrounded by two electric coils (8, 9). It is possible to install only one coil in an alternative embodiment, the two coils (8 and 9) being, for this example, arranged on either side of the guide axis (6) for the sake of balance and space optimization.

By way of example, each coil consists of 56 turns (28 turns/pocket), in series with a 0.28 mm copper wire, the coil having a terminal resistance of 0.264Ω.

To reverse the polarity of the magnetization of the low-coercive-field magnet (7), a current is applied to the coil(s) (8, 9) in the form of a direct current or an electrical pulse, for example, given by discharging a capacitor. By way of example, a current of 13 amperes that generates a magnetomotive force of approximately 730 At makes it possible to modify the magnetization.

The operation of this first embodiment is as follows: When a direct current or a current pulse in a positive direction (arbitrary reference) flows through the coils (8, 9), creating an additive magnetic field between the two coils, the low-coercive-field magnet (7) is magnetized in a direction such that the magnetic fluxes of the two magnets are additive and flow mainly in a loop through the two magnets (5, 7) and the semi-tubular parts (4a, 4b). As a result, there is little or no magnetic flux through the first structure (1) and there is little or no coupling between the two structures (1, 3), and so the user activating the structure does not feel any notching. In this specific example, the magnetizations of the two magnets (5, 7) are parallel and perpendicular to the median plane between the two semi-tubular parts (3, 4), although this configuration is not exclusive.

When a current pulse in a negative direction (arbitrary reference) flows through the coils

(8, 9), creating a magnetic field that is again additive between the two coils, the low-coercive-field magnet (7) is magnetized in a direction such that the magnetic fluxes of the two magnets are subtractive and flow mainly in a loop through the two magnets (5, 7) and the two toothed structures (1, 3). This results in marked coupling or notching and a significant indexing sensation is perceived by the user of the device, who thus feels a notching.

The intensity of the current in the coils (8, 9) advantageously makes it possible to adjust the haptic sensation by directly influencing the intensity of the magnetization of the low-coercive-field magnet (7) and therefore the coupling flux between the stationary and movable structures.

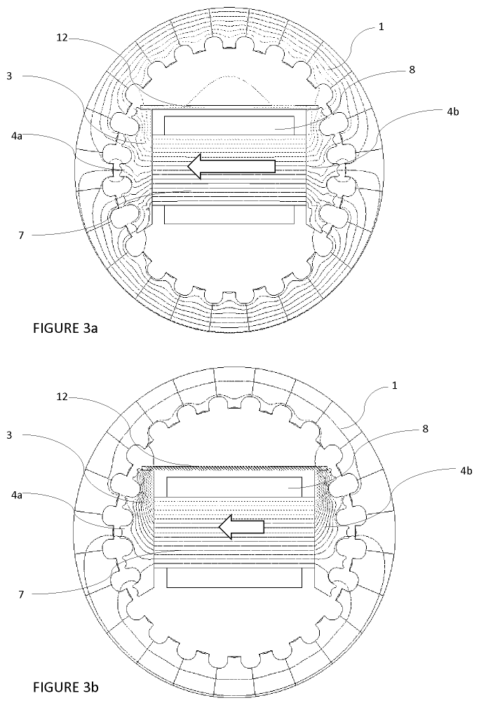

FIGS. 3a and 3b show a variant of a device according to the present disclosure for which only a low-coercivity magnet (7) is present in association with a coil (8) surrounding the magnet (7). In this variant, the functions of the first (1) and second (3) toothed structures already described for the previous embodiment are maintained. In this variant, the two semi-tubular parts

Semi-tubular parts (4a, 4b) are also interconnected by a short-circuit path (12) made of soft ferromagnetic material. The thick arrows show the direction of magnetization of the magnet (7) and the length of this arrow symbolizes the intensity of this magnetization.

The operation of this variant is as follows: When the low-coercive-field magnet (7) is magnetized to saturation, that is to say when the magnetization has maximum intensity, the short-circuit path (12) is magnetically saturated and its magnetic permeability is low and approaches that of the air. In this case (FIG. 3a), the magnetic field generated by the low-coercive-field magnet (7) mainly passes through the first (1) and second (3) toothed structures, which promotes the creation of a periodic torque, which causes the notching effect and therefore the haptic sensation felt by the user manipulating the second structure (3). Under the current pulse given to the coil (8), the low-coercive-field magnet (7) demagnetizes, at least partially, and the intensity of the magnetization is reduced. As a result, the short circuit path is no longer magnetically saturated and the majority of the magnetic flux produced by the low-coercive-field magnet (7) loops through the short-circuit path (12) (FIG. 3b). This results in a drastically reduced magnetic field between the teeth (2) of the first (1) and second (3) structures, correspondingly reducing the notching and the haptic sensation of the user. By influencing the intensity of the pulse current in the coil (8), it is possible to adjust the level of residual magnetization in the low-coercive-field magnet (7) and thus to adjust the intensity of the notching obtained.

It should be noted that the use of the short-circuit path (12) is not absolutely essential to the present disclosure and is used only with the aim of giving a tolerance in the minimum magnetization of the magnet (7). It is thus possible to dispense with the short-circuit path (12) by influencing only the intensity of pulse current of the coil (8) in order to adjust the level of residual magnetization of the low-coercive-field magnet (7).

By way of example, if after demagnetization the low-coercive-field magnet (7) provides a field 10 times smaller than that which it has at saturation, the residual torque observed is typically more than 100 times smaller.

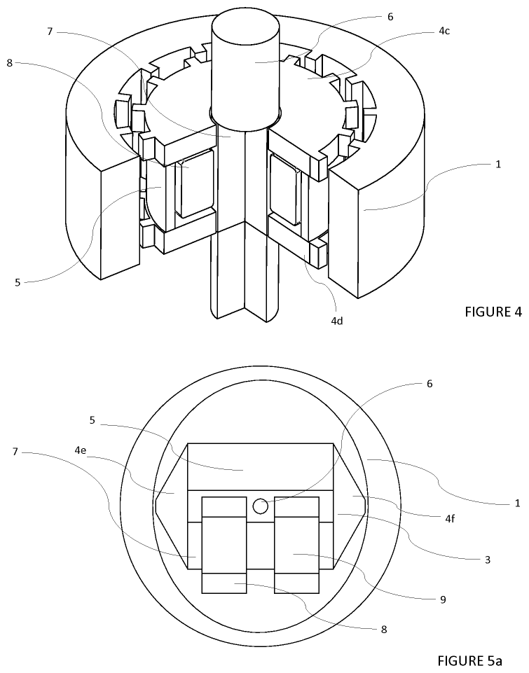

FIG. 4 shows a variant in which the second ferromagnetic structure is formed of two toothed disks (4c, 4d) forming two main air gaps with the first structure (1) in the region of the teeth formed at the interface of the two structures. The first, high-coercive-field permanent magnet (5) has a tubular shape and axial magnetization. The second, low-coercive-field permanent magnet (7) is coaxial with the first permanent magnet (5) and has a cylindrical shape and an axial magnetization, and is in this case rigidly connected to the axis (6). The coil (8) surrounds the low-coercive-field magnet (7). The operation otherwise remains similar to that described in the first example above insofar as the direction of the electrical pulse given to the coil (8) will magnetize the low-coercive-field magnet (7) in a first axial direction, or a second opposite axial direction, and make the magnetic fields additive or subtractive in order to create or suppress the notching.

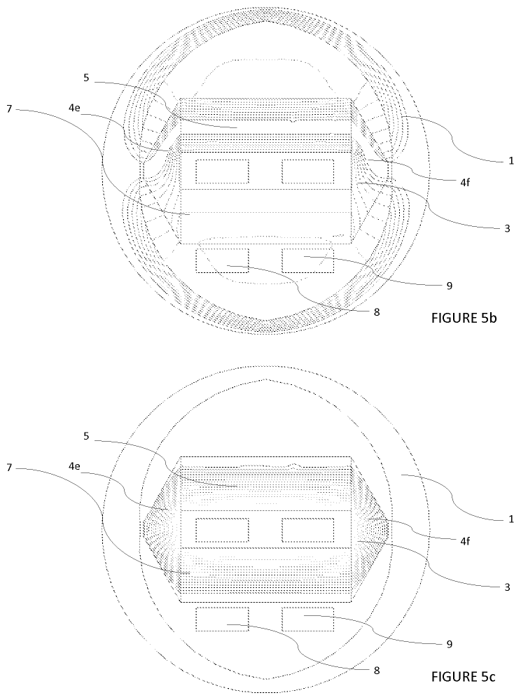

FIGS. 5a to 5c are similar views, from above, of an alternative embodiment of a device according to the present disclosure. Unlike the embodiments presented above, the first structure (1) and the second structure (3) do not have any teeth. The second structure (3) is, in particular, terminated at its two ends by pole pieces (4e, 4f) forming points. The variation in reluctance between these two structures (1) and (3) is achieved by a continuously variable air gap at the pole pieces (4e, 4f), for example, in this case due to a roughly elliptical shape given to the first structure (1), without this shape being limiting. The operation is also similar to that presented above. FIG. 5b shows the case in which the permanent magnet (5) and the low-coercivity magnet (7) have a direction of magnetization in the same direction, which promotes looping of the magnetic flux in the first (1) and second structure (3) and thus a force between these two elements. In FIG. 5c, the directions of magnetization of the permanent magnet (5) and the low-coercivity magnet (7) are opposite so that the magnetic flux flows predominantly inside the second structure (3), which minimizes or even cancels out the force exerted between the two structures (1) and (3).

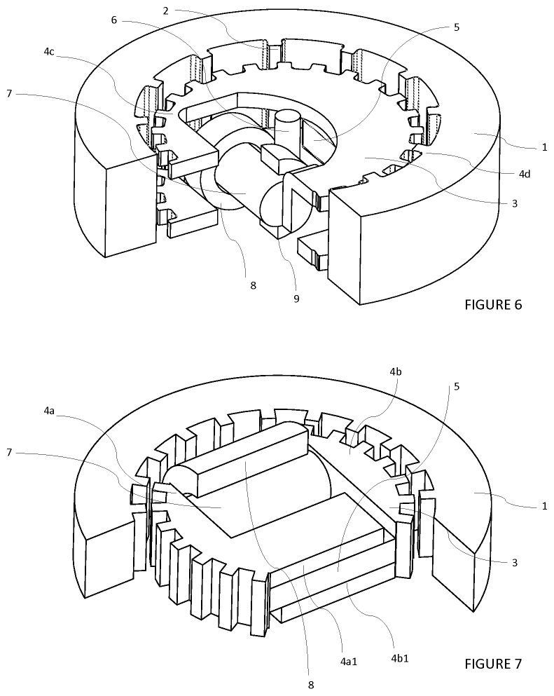

FIG. 6 is another alternative embodiment that repeats the use of the toothed structures (1) and (3) presented above. This present variant differs from the first embodiments, on the one hand, by the design of the second structure (3) that is in contact with the permanent magnet (5) and the low-coercivity magnet (7) and in this case is in the form of folded sheets terminated by teeth, and on the other hand by the different number of teeth (2) between the two structures (1) and (3). The permanent magnet (5) is in the form of a parallelepiped and the low-coercivity magnet (7) is in the form of a cylinder around which the activation coils (8, 9) are wound on either side of the axis (6).

FIG. 7 is another alternative embodiment that differs mainly from those above in that the permanent magnet (5) is axially placed between planar extensions (4a1, 4b1) of the toothed semi-tubular parts (4a, 4b) of the second structure (3). The permanent magnet (5) in this case has an axial magnetization relative to the rotation of the first structure (1) and a single coil (8) is positioned around the low-coercivity magnet (7), the latter having a direction of magnetization perpendicular to the axis of rotation.

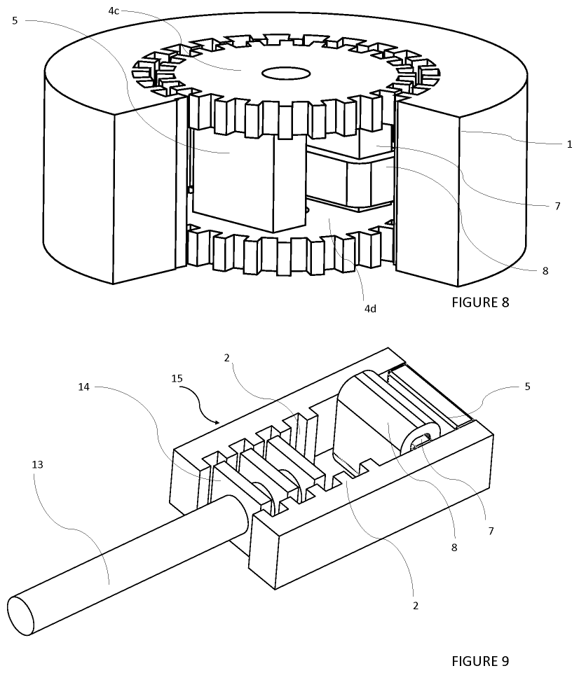

FIG. 8 is an embodiment similar to that of FIG. 4, with the difference that the permanent magnet (5) and the low-coercivity magnet (7) are not coaxial. The permanent magnet (5) extends axially with a direction of magnetization that is also axial and the low-coercivity magnet (7) is parallel to the permanent magnet (5) surrounded by a coil (8).

FIG. 9 is an embodiment of a linear movement device according to the present disclosure. It consists of a linearly movable element (13) in the form of a rod or bar—the shape not being limiting—terminated by a toothed flux collector (14) that magnetically cooperates with the teeth (2) of the stator (15). The stator (15) and the linearly movable element (13) are the equivalents of the first (1) and second structure (3), respectively, of the rotary cases. The stator (15) thus has a permanent magnet (5) extending perpendicularly to the linearly movable element (13), the magnetization thereof being directed along this extension. The low-coercivity magnet (7) extends in parallel with the permanent magnet (5) and is surrounded by the coil (8), allowing its magnetization to be modulated.

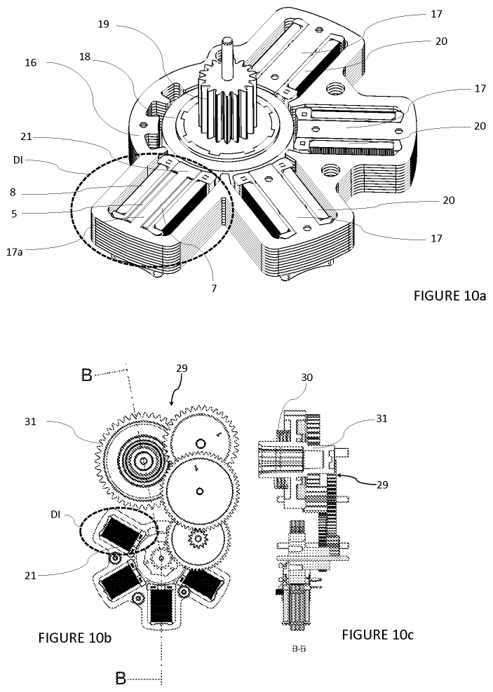

FIGS. 10a and 11 are two particular variants of devices, according to the present disclosure, that are intended to incorporate a variable and controllable force in an electric motor or actuator.

In FIG. 10a, a device according to the present disclosure, delimited by the dotted ellipse (DI), is integrated in a motor comprising a motor stator (16) having poles (17) that extend radially relative to a magnetized rotor (18). In the example given here, this magnetized rotor (18) carries a pinion (19) intended to drive an external member or a mechanical reduction gear. Three poles (17) carry motor coils (20) in order to generate the rotating field driving the magnetic rotor (18), the number of poles not being limiting. One particular pole (17a) of the motor stator (16) is associated with a permanent magnet (5) extending in parallel with the particular pole (17a), the direction of magnetization thereof being along this extension, and with a low-coercivity magnet (7) parallel to the permanent magnet (5). The particular pole (17a) is surrounded by an activation coil (8) and has an end (21), on the magnetized rotor (18) side that makes it possible to magnetically connect the permanent magnet (5) and the low-coercivity magnet (7). Depending on the current pulse flowing through the coil (8), the low-coercivity magnet has a direction of magnetization in the same direction or the opposite direction to that of the permanent magnet (5). If the magnetizations are in the same direction, the magnetic fluxes of the two magnets (5) and (7) spread out from the end (21) and interact with the magnetized rotor (18) in order to create a force holding the magnetized rotor (18) in position or returning the magnetized rotor (18) to a predefined position. If the magnetizations are in opposite directions to one other, the magnetic fluxes of the two magnets (5) and (7) loop in the end (21) without interacting with the magnetized rotor (18), creating no force on the latter.

A device according to the present disclosure makes it possible to introduce a controllable force into an electric motor or actuator by making it possible to add, for example: a torque for maintaining a defined position, a torque for returning to a predefined position, or a periodic residual torque.

For example, in FIG. 10b, the motor of FIG. 10a is associated with a motion reduction gear (29) and a torsion spring (30) to form a gear motor of which the return to a reference position (the so-called fail-safe position) is controlled by a device according to the present disclosure, delimited by the dotted ellipse (DI). The torsion spring (30) is positioned at the output wheel (31) and applies a torque thereto. In an operating mode in which the motor must reach a given position, the device according to the present disclosure is active in such a way that it creates a magnetic interaction between the magnetized rotor (18) and the end (21) generating a torque on the magnetized rotor (18). By the play of the motion reduction gear (29), this magnetic torque is amplified and dimensioned to be greater than the torque generated at the output wheel (31) by the torsion spring (30). Thus, the device can hold any position without consuming current. On the other hand, if the device according to the present disclosure is rendered inactive by reversing the magnetization at the low-coercivity magnet (7), the magnetic interaction torque between the magnetized rotor (18) and the end (21) is suppressed or minimized. As a result, the torque from the torsion spring (30) applied to the output wheel generates a force that will return the output wheel (31) to a predefined position (by virtue of a stopper, for example). Thus, the device according to the present disclosure makes it possible to achieve a controllable return/fail-safe force. The aim is to be able to minimize the size of the motor, which does not have to constantly overcome the return force of the torsion spring (30) with current.

An example of the application of this particular embodiment, including a device according to the present disclosure associated with a reduction gear and with a spring on the output wheel of the reduction gear, is its use in a door closer. In this case, for example, it is possible to minimize the closing time of the door over most of its travel by minimizing the interaction torque at the device according to the present disclosure, and then to brake the closing over the last part of the door's travel by generating an interaction torque. The dimensioning of the device will make it possible to modify the desired braking characteristic on demand by also influencing the magnetization cycles of the low-coercive-field magnet (7) during the closing of the door. It should be noted that this application can also be conceived with a device such as shown in FIGS. 13a and 13b.

FIG. 11 is a variant of this controllable force device integrated in an electric motor, the stator of which shares similarities with that of FIG. 10, with referenced elements in common. In this example case, however, the device is integrated inside the magnetized rotor (18) and does not have a particular pole. The stator is in fact a conventional, unmodified stator of an electric motor. The magnetized rotor (18) comprises a ferromagnetic yoke (22) that is equivalent to the first structure (1) of the device shown in FIG. 1. Inside this first structure (1), the same elements can be found as in FIG. 1. The controllable interaction between the yoke (22) and the second, stationary structure (3) makes it possible to modulate the force applied to the magnetized rotor (18).

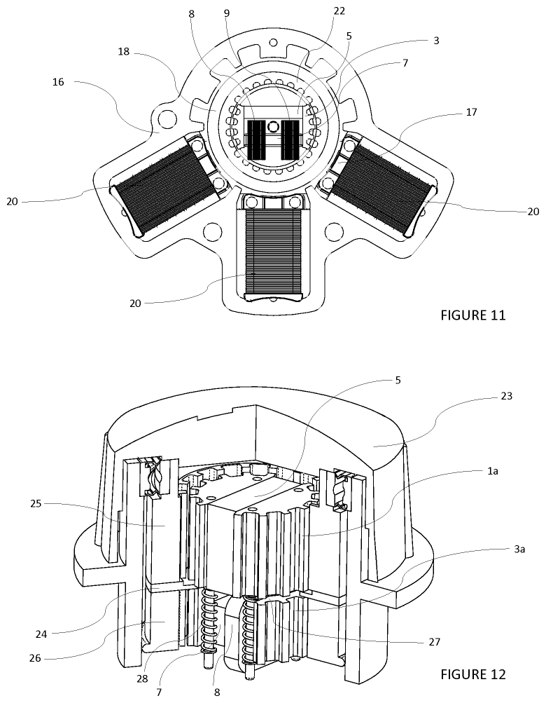

FIG. 12 shows a manually controllable button (23) incorporating a device according to the present disclosure for which the interaction between a first toothed structure (la) and a second toothed structure (3a) is used to control a blocking force. The first structure (la) and the second structure (3a) are axially movable with respect to one another, the permanent magnet (5) being integrated in the plane of the first structure (1) and the low-coercivity magnet (7) and the activation coil (8) being integrated in the plane of the second structure (3a). At the interface between the two structures (la, 3b) there is a braking disk (24) that extends radially and is rigidly connected to the toothed support (25) of the button (23). The braking disk (24) is therefore rigidly connected to the button (23).

When the direction of magnetization of the low-coercivity magnet (7) is identical to that of the permanent magnet (5), the magnetic flux of the two magnets (5, 7) flows in the toothed support (25) of the button (23) and in the toothed support (26) of the first structure (la), respectively, thus creating a notching force felt by the user of the button (23). When the direction of magnetization of the low-coercivity magnet (7) is opposite to that of the permanent magnet (5), the magnetic flux of the two magnets (5, 7) flows mainly in the air gap (27) between the two structures (la, 3a), which promotes the closing of this air gap (27) and therefore the clamping of the braking disk (24) between the two supports (25, 26). The return to the notched state can then be achieved by changing the direction of magnetization of the low-coercivity magnet (7) and by re-opening the air gap (27) due to the action of one or more springs (28). It is thus possible, by virtue of a device according to the present disclosure, to not only achieve a notching sensation but also to simulate an arrival at the stop by blocking the movement of the button.

FIGS. 13a and 13b are views from above and in perspective, respectively, of a device according to the present disclosure (DI)—which is, in this case, according to the embodiment given in FIG. 1—associated with a mechanical motion reduction gear (29) and a pushing device (32). The latter consists of a compression spring (33) and a support plane (34). The motion reduction gear (29) has, on the output wheel (31), a capstan (35) on which a cable (36) is wound that is further connected to the planar support (34). The compression spring (33) is secured on one longitudinal side (A) and applies a force to the support plane (34) on the other longitudinal side (B). By managing the magnetization of the device according to the present disclosure, it is possible to create a force of magnetic origin at the device. The torque applied to the output wheel (31) and therefore to the capstan (35), by the play of the reduction gear (29), is amplified and dimensioned so as to retain the cable (36) against the force of the spring (33). By modifying the magnetization at the device according to the present disclosure, the force of magnetic origin is eliminated or minimized, which eliminates or minimizes the force at the capstan (35) and thus allows the spring (33) to advance the support plane in the direction of the thick arrow in FIG. 13a. Thus, this device, which could also be applied to a support plane with angular movement, could advantageously manage the force of a compression spring to achieve a progressive advancement of the support plane (34). For example, the use of such a device can be imagined for a syringe pump or to manage the dosage of any dispenser, or even to manage the closing of a door.

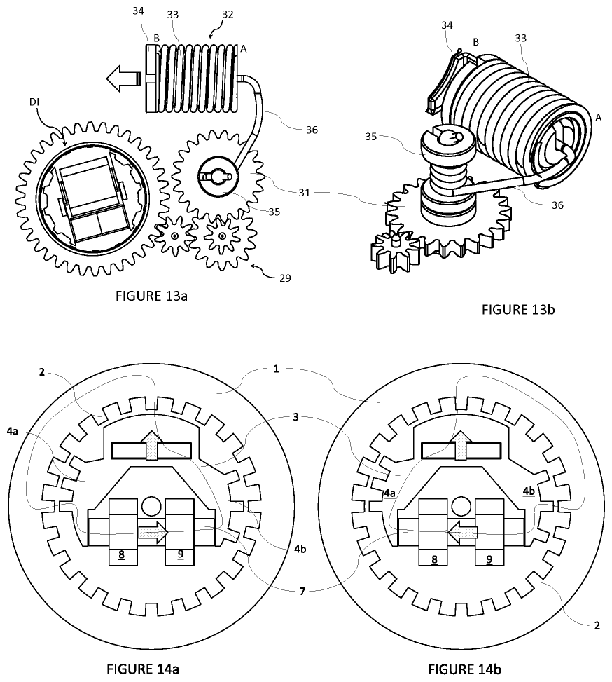

FIGS. 14a and 14b show two magnetic configurations of the same topology, the purpose of which is to allow a different number of notches felt depending on the direction of magnetization of the low-coercive-field magnet (7). Oriented as shown by the thick arrow in FIG. 14a, the magnetization of this magnet (7) is such that it generates a magnetic flux flowing between the first and second structures (1, 3) by a first pattern of teeth that are carried by a part (4a) of the second structure (3) and are spaced in this configuration by a period identical to that of the teeth (2) of the first structure (1).

According to the second configuration shown in FIG. 14b, and as symbolized by the thick arrow, the magnetization of the magnet (7) is in a direction opposite to that described above and the magnetic flux flows between the first and second structures (1, 3) by the second pattern of teeth that are carried by a part (4b) of the second structure (3) and are spaced so as to create a second mechanical period for the torque. The mechanical frequency of the torque created according to this second configuration is equal to the LCM between the number of evenly spaced teeth on the first structure (1) and the number of teeth on the second structure (3) that are evenly spaced according to the second pattern of teeth carried by the part (4b). The number of teeth to be placed on this pattern is equal to the number of evenly spaced teeth on the second pattern of teeth carried by the part (4b) divided by the GCD between this number of teeth and the number of teeth of the first structure (1).

In the case shown, there are 24 teeth evenly spaced at 15° on the first structure (1) and 3 teeth spaced at 15° on the first pattern of teeth carried by the part (4a) of the stator. The mechanical period of the torque created is 360/LCM (24; 360/15°) or 15°. The second pattern of teeth carried by a part (4b) has 3 teeth spaced apart at 20°. The mechanical period of the torque created is 360/LCM (24; 360/20=18) or 5°.

The number of teeth to be placed on this second pattern of teeth carried by a part (4b) is: 18 teeth/GCD (18; 24)=3.

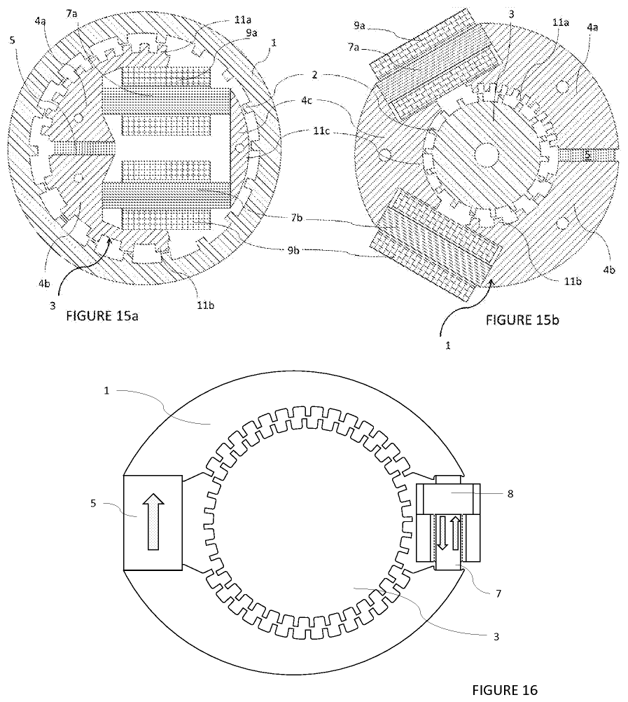

FIG. 15a is an extended version of the embodiment in FIGS. 14a and 14b that makes it possible to obtain 4 different operating modes. The embodiment has a first toothed structure (1) in the form of a ring having teeth (2) that are distributed over its inner surface and directed radially inward, a second ferromagnetic structure (3) comprising in this case three semi-tubular parts (4a, 4b and 4c), a high-coercive-field permanent magnet (5) and two low-coercive-field magnets (7a and 7b). The latter are each surrounded by a coil making it possible to reverse and/or modulate their magnetization (9a and 9b, respectively).

The semi-tubular parts (4a, 4b) each have, on their outer cylindrical side, a set of teeth (11a, 11b) allowing them to interact with that of the ring. The semi-tubular part (4c) has a shape that makes it possible to ensure the looping of the flux and to optimize the magnetic torque. In this case, it does not have teeth but a constant radius (11c) in order to ensure looping of the magnetic flux in any relative position of the first structure (1) with respect to the second structure (3).

The second ferromagnetic structure (3) is produced by alternating the magnets (5, 7a and 7b) and the semi-tubular parts (4a, 4b and 4c) in the orthoradial direction. In this way, the device can have substantially zero torque if the direction of magnetization of all the magnets is selected such that the magnetic flux only loops through the second ferromagnetic structure (3). By changing the direction of magnetization of one or more low-coercive-field magnets (7a or 7b), the magnetic flux will be directed toward the first toothed structure (1) through only 2 of the semi-tubular parts (4a, 4b) or (4a, 4c) or (4b, 4c), thus obtaining 3 distinct magnetostatic torques depending on the geometric characteristics of the first and the second ferromagnetic structure (1, 3), according to the teachings of FIGS. 14a and 14b.

FIG. 15b is an alternative embodiment to that presented in FIG. 15a, which also makes it possible to obtain 4 different operating modes. For this purpose, the embodiment has a first toothed structure (1) in the form of a ring with teeth (2) that are distributed over its inner surface, comprising in this case three semi-tubular parts (4a, 4b and 4c), a high-coercive-field permanent magnet (5) and two low-coercive-field magnets (7a and 7b). The latter are each surrounded by a coil making it possible to reverse and/or modulate their magnetization (9a and 9b, respectively). A second ferromagnetic structure (3) is present inside the first structure (1) and comprises a set of evenly distributed teeth (2).

The semi-cylindrical parts (4a, 4b) each have, on their inner cylindrical side, a set of teeth (11a, 11b, respectively) allowing them to interact with that of the rotor. The semi-tubular part (4c) has a shape that makes it possible to ensure the looping of the flux and to optimize the magnetic torque. In this case, it does not have teeth but a constant radius (11c) in order to ensure looping of the magnetic flux in any relative position of the first structure (1) with respect to the second structure (3).

In the configuration shown in FIG. 16, depending on the direction of orientation of the low-coercive-field magnet (7) and taking account of the teachings already indicated above, the magnetic flux flows mainly in the first structure (1), without interacting, or interacting a little, with the second structure (3), or else the magnetic flux flows in the second structure (3) via the teeth and then creates a torque depending on the relative position of the first structure (1) with respect to the second structure (3). The magnetic cooperation with the high-coercive-field permanent magnet (5), which is the cause of this effect, therefore depends on the direction of orientation of the magnetization of the low-coercive-field magnet (7) that is induced by the electric coil (8) surrounding it. Such a device can, in particular, and by way of example, be used to create an additional position-holding function for a device that has to be clamped or released on demand.

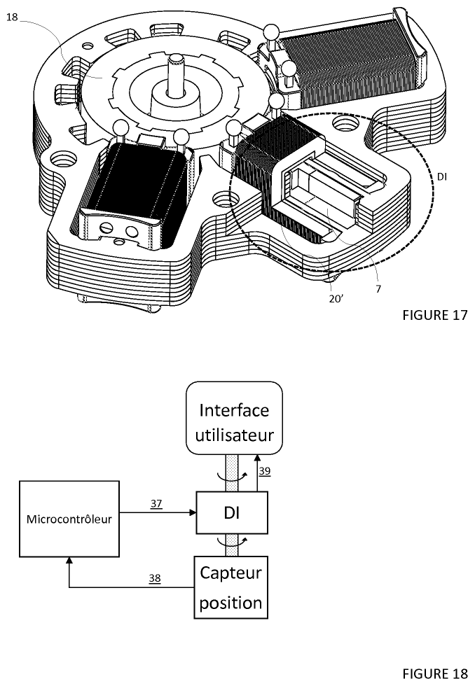

FIG. 17 shows an alternative embodiment to that proposed or shown in FIGS. 10a-10c. In this embodiment, the device according to the present disclosure (DI) is integrated directly in one of the control coils (20′) of the motor. As such, the functionality according to which the notching, or the lack of notching by magnetic interaction with the magnetized rotor (18) of the motor can be controlled directly by a coil (20′) that is an electrical phase of the motor. When controlling the motor, the electric current flowing in the coil (20′) must not exceed the limit for modifying the permanent magnetization of the low-coercive-field magnet (7). It should be noted that the device (DI) can be produced in different ways, taking the example of the cases presented above.

FIG. 18 is a block diagram of a device according to the present disclosure (DI) when integrated in a complete system for managing a user interface. In this example, the device according to the present disclosure (DI) is rigidly connected to this user interface and also to a position sensor and it is controlled by a microcontroller. According to this embodiment, depending on the signal indicating the position of the interface that is detected by the position sensor and sent back to the microcontroller via the signal (38), this microcontroller will control the coil(s) of the device according to the present disclosure (DI) via the control signal (37). By creating, modifying or canceling the notching according to the functions described above, the device according to the present disclosure (DI) can thus dynamically modify—that is to say during operation and depending on the position of the interface—what the user feels by action (39) of the device according to the present disclosure on the user interface.

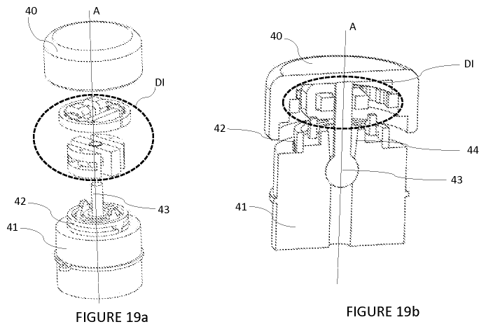

FIGS. 19a and 19b are two different views, one exploded and one in longitudinal section, of the same user interface using a device according to the present disclosure (DI). In this example, this device (DI) is integrated inside an interface (40) that can be rotated by a user according to the three possible degrees of freedom in rotation. The device (DI) thus makes it possible to modify what the user feels depending on the configuration of the device (DI) according to the teachings described above in either example. In this example, the second structure (3) is rigidly connected to a ball-joint finger (43) that therefore allows three degrees of freedom in rotation. The rotation about the main axis (A) of rotation of the device is free while the other two degrees of freedom in rotation are limited by mechanical cooperation of the ball-joint finger (43) with the support (41), which has the shape of a cone. (44). It is also conceivable to allow an additional degree of freedom in translation along the axis (A).

1. An adjustable force device, comprising:
a mechanically guided member for allowing a displacement of the member along a predetermined trajectory; and
a mechanism for magnetically indexing the displacement of the member by a magnetic interaction between a first ferromagnetic structure and a second ferromagnetic structure rigidly connected to a magnet, wherein the magnet is surrounded at least partially by an electric coil configured to modify a magnetization of the permanent magnet according to a direction and amplitude of an electric current flowing in the coil.

2. The device of claim 1, wherein the magnet is a magnet with a coercive field of less than 100 kA/m.

3. The device of claim 1, wherein the second magnetized ferromagnetic structure is also rigidly connected to a second permanent magnet with a coercive field of greater than 100 kA/m.

4. The device of claim 1, wherein the second ferromagnetic structure is also magnetically closed by a magnetic short-circuit connecting two opposite polarities of the magnet.

5. The device of claim 1, wherein the second ferromagnetic structure defines, with the first ferromagnetic structure, a first air gap on a side of a first polarity of the magnet and a second air gap on a side of a second polarity of the magnet.

6. The device of claim 1, further comprising an electronic circuit controlling a power supply to the coil in a pulsed manner.

7. The device of claim 3, wherein the first ferromagnetic structure and second ferromagnetic structure have teeth, and the second ferromagnetic structure consists of two toothed semi-tubular parts connected by the second magnet and by the first magnet, the directions of magnetization of the two magnets being parallel.

8. The device of claim 7, wherein the angular deviation between the teeth is identical between the first and second ferromagnetic structures.

9. The device of claim 7, wherein the angular deviation between the teeth is different between the first and second ferromagnetic structures.

10. The device of claim 1, wherein the second ferromagnetic structure comprises two coaxial disks separated by two magnets, which magnets have a tubular shape and axial magnetization and are arranged coaxially with the disks.

11. The device of claim 1, wherein the device is rotary and the first ferromagnetic structure and the second ferromagnetic structure form a variable air gap according to the relative angular position of the first ferromagnetic structure and the second ferromagnetic structure.

12. An electric motor comprising an adjustable force device according to claim 1, wherein the adjustable force device is integrated in a stator of the electric motor and the adjustable force device controls a force for holding in a stable position or returning to a predefined position.

13. An electric motor comprising an adjustable force device according to claim 1, wherein the first ferromagnetic structure comprises a cylinder head of the electric motor and the adjustable force device controls a force for holding in a stable position or returning to a predefined position.

14. The device of claim 1, wherein the adjustable force device is associated with a motion reduction gear and an output wheel of the motion reduction gear is rigidly connected to a capstan, and where a cable is rigidly connected to the capstan and to a support plane and a spring applies a force or torque to the planar support.

15. A door closing mechanism comprising an adjustable force device according to claim 1, wherein the adjustable force device controls a closing speed of a door by modifying the magnetization of the magnet.

16. The device of claim 2, wherein the second magnetized ferromagnetic structure is also rigidly connected to a second permanent magnet with a coercive field of greater than 100 kA/m.

17. The device of claim 16, wherein the second ferromagnetic structure is also magnetically closed by a magnetic short-circuit connecting two opposite polarities of the magnet.

18. The device of claim 17, wherein the second ferromagnetic structure defines, with the first ferromagnetic structure, a first air gap on a side of a first polarity of the magnet and a second air gap on a side of a second polarity of the magnet.

19. The device of claim 18, further comprising an electronic circuit controlling a power supply to the coil in a pulsed manner.
